(19) United States
(12) Patent Application Publication
(10) Pub. No.: US 2026/0246919 A1
(43) Pub. Date: Aug. 20, 2026

(54) Method and Apparatus of Implicit Linear Model Derivation using Multiple Reference Lines for Cross-component Prediction

(71) Applicant: MEDIATEK INC., Hsinchu City (TW)

(72) Inventors: Hsin-Yi TSENG, Hsinchu City (TW); Man-Shu CHIANG, Hsinchu City (TW); Chih-Wei HSU, Hsinchu City (TW)

(21) Appl. No.: 19/115,118

(22) PCT Filed: Sep. 28, 2023
(86) PCT No.: PCT/CN2023/122901

§ 371 Date: Mar. 25, 2025

Related U.S. Application Data
(60) Provisional application No. 63/378,704, filed on Oct. 7, 2022.

(51) Int. Cl. H04N 19/105; H04N 19/174; H04N 19/176; H04N 19/186

(52) U.S. Cl. CPC H04N 19/105; H04N 19/174; H04N 19/176; H04N 19/186

(57) ABSTRACT

A method and apparatus for cross-component intra prediction. A model parameter set is derived for each of one or more cross-component models based on first-colour samples and second-colour samples in the reference lines. Predicted samples associated with each of one or more cross-component models are derived for the second-colour component of the template by applying the cross-component model parameter set associated with said each of one or more cross-component models to the first-colour component of the template. A template cost associated with said each of one or more cross-component models is determined based on the predicted samples of the templates associated with said each of one or more cross-component models and reconstructed samples of the templates. Target modes are then determined from said one or more cross-component models for the second-colour component of the current block according to template costs associated with said one or more cross-component models.

### CROSS REFERENCE TO RELATED APPLICATIONS

The present invention is a non-Provisional application of and claims priority to U.S. Provisional Patent Application No. 63/378,704, filed on Oct. 7, 2022. The U.S. Provisional Patent Application is hereby incorporated by reference in its entirety.

### FIELD OF THE INVENTION

The present invention relates to video coding system. In particular, the present invention relates to a new video coding tool by blending a cross-component linear model predictor and using multiple reference lines in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264, VVC or any other video coding standard.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In the present disclosure, various new coding tools are presented to improve the coding efficiency beyond the VVC. In particular, a new coding tool relates to blending cross-component model modes and using multiple reference lines is disclosed.

### BRIEF SUMMARY OF THE INVENTION

A method and apparatus for prediction in video coding system are disclosed. According to the method, input data associated with a current block comprising a first-colour component and a second-colour component are received, wherein the input data comprise pixel data to be encoded at an encoder side or coded data associated with the current block to be decoded at a decoder side. One or more templates of the current block are determined, wherein said one or more templates of the current block are located in a previously coded region of the current block. One or more first reference lines are selected from available reference lines of the current block. A cross-component model parameter set for each of one or more cross-component models are derived based on first-colour samples and second-colour samples in said one or more first reference lines. Predicted samples of said one or more templates associated with said each of one or more cross-component models for the second-colour component of said one or more templates are derived by applying the cross-component model parameter set associated with said each of one or more cross-component models to the first-colour component of said one or more templates. A template cost associated with said each of one or more cross-component models are determined based on the predicted samples of said one or more templates associated with said each of one or more cross-component models and reconstructed samples of said one or more templates. One or more target modes from said one or more cross-component models are determined for the second-colour component of the current block according to the template costs associated with said one or more cross-component models. One or more second reference lines from the available reference lines of the current block are selected, wherein said one or more second reference lines are allowed to be the same as said one or more first reference lines. The cross-component model parameter sets for said one or more target modes are derived based on the first-colour samples and the second-colour samples in said one or more second reference lines if said one or more second reference lines are different from said one or more first reference lines. The second-colour component of the current block is encoded or decoded using coding information comprising said one or more target modes and the cross-component model parameter sets derived by said one or more second reference lines.

In one embodiment, the template cost associated with said each of one or more cross-component models corresponds to distortion between the predicted samples of said one or more templates associated with said each of one or more cross-component models and the reconstructed samples of said one or more templates. In one embodiment, said one or more target modes selected from said one or more cross-component models have smallest template costs among the template costs associated with said one or more cross-component models.

In one embodiment, the current block is encoded or decoded using a final predictor by blending a first predictor associated with a first prediction mode and a second predictor associated with a second prediction mode, and wherein at least one of the first prediction mode and the second prediction mode is implicitly determined according to the template costs associated with said one or more cross-component models. In one embodiment, the first prediction mode is determined explicitly by signalling or parsing an index, and said one or more cross-component models are associated with a cross-component model set and the second prediction mode is determined implicitly according to the template costs associated with said one or more cross-component models in the cross-component model set. In one embodiment, the final predictor is generated as a weighted sum of the first predictor and the second predictor. In one embodiment, a weighting factor for the weighted sum of the first predictor and the second predictor is determined implicitly based on a first template cost associated with the first prediction mode and a second template cost associated with the second prediction mode.

In one embodiment, the first template cost is determined by deriving a first cross-component parameter set based on the samples on said one or more first reference lines and a signalled first prediction mode, and then determined based on the predicted samples of said one or more templates and reconstructed samples of said one or more templates, and wherein the predicted samples of said one or more templates are generated according to the signalled first prediction mode with the first cross-component parameter set derived.

In one embodiment, a flag is signalled or parsed to indicate whether MRL (Multiple Reference Lines) mode is enabled for the current block. In one embodiment, when the flag indicates the MRL mode being enabled for the current block, the second prediction mode is determined and a weighting factor for the weighted sum of the first predictor and the second predictor is derived. In one embodiment, the first predictor is generated based on one cross-component parameter set derived based on said one or more second reference lines with the first prediction mode. In one embodiment, said one or more first reference lines from the available reference lines correspond to one or more outer adjacent reference lines of said one or more templates of the current block, and the second reference lines are the same as the first reference lines.

In one embodiment, said one or more cross-component models are associated with a second cross-component model set, the flag is signalled only if the first prediction mode is in the second cross-component model set. In one embodiment, if the first prediction mode is not in the second cross-component model set, the flag is not signalled and the MRL mode is implicitly determined as disabled.

In one embodiment, said one or more cross-component models are associated with a first cross-component model set and a second cross-component model set, and wherein a first target mode is derived from the first cross-component model set and a second target mode is derived from the second cross-component model set. In one embodiment, the final predictor is generated as a weighted sum of the first predictor and the second predictor. In one embodiment, a weighting factor for the weighted sum of the first predictor and the second predictor is determined implicitly based on a first template cost associated with the first prediction mode and a second template cost associated with the second prediction mode. In one embodiment, a flag is signalled or parsed to indicate whether MRL (Multiple Reference Lines) mode is enabled for the current block. In one embodiment, when the flag indicates the MRL mode being enabled for the current block, the first prediction mode and the second prediction mode are determined and the weighting factor for the weighted sum of the first predictor and the second predictor is derived.

In one embodiment, the first cross-component model set and the second cross-component model set only contain linear model modes. In one embodiment, the first prediction mode is determined implicitly from the first cross-component model set and the second prediction mode is determined implicitly from the second cross-component model set.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of directional (angular), Planar and DC modes for Intra prediction according to the VVC standard.

FIGS. 3A-B illustrate examples of wide-angle intra prediction a block with width larger than height (FIG. 3A) and a block with height larger than width (FIG. 3B).

FIG. 4 shows an example of the location of the left and above samples and the sample of the current block involved in the CCLM_LT mode.

FIG. 5 illustrates an example of template-based intra mode derivation (TIMD) mode, where TIMD implicitly derives the intra prediction mode of a CU using a neighbouring template at both the encoder and decoder.

FIG. 6 illustrates an example of spatial part of the convolutional filter for CCCM.

FIG. 7 illustrates an example of reference area (with its paddings) used to derive the CCCM filter coefficients.

FIG. 8 illustrates an example of 4 gradient patterns for Gradient Linear Model (GLM).

FIG. 9 illustrates an example of the outer adjacent line of the template being selected to be the reference line of the template and the outer adjacent line of the current block being selected to be the reference line of the encoding block.

FIG. 10 illustrates an example of the outer adjacent line of the template being selected to be the reference line of the template and the reference line of the encoding block being also the outer adjacent line of the template.

FIG. 11 illustrates an example of both the reference line of the template and the reference line of the current block being the outer adjacent line of the current block.

FIG. 12 illustrates an example of both the reference line of the template and the reference line of the current block being the outer adjacent line of the current block.

FIG. 13 illustrates an example of multiple reference lines for the current block to derive cross-component model parameters.

FIG. 14 illustrates a flowchart of an exemplary video coding system that implicitly derives a linear model predictor based on TIMD (Template-based Intra Mode Derivation) according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The VVC standard incorporates various new coding tools to further improve the coding efficiency over the HEVC standard. Among various new coding tools, some coding tools relevant to the present invention are reviewed as follows.

Intra Mode Coding with 67 Intra Prediction Modes

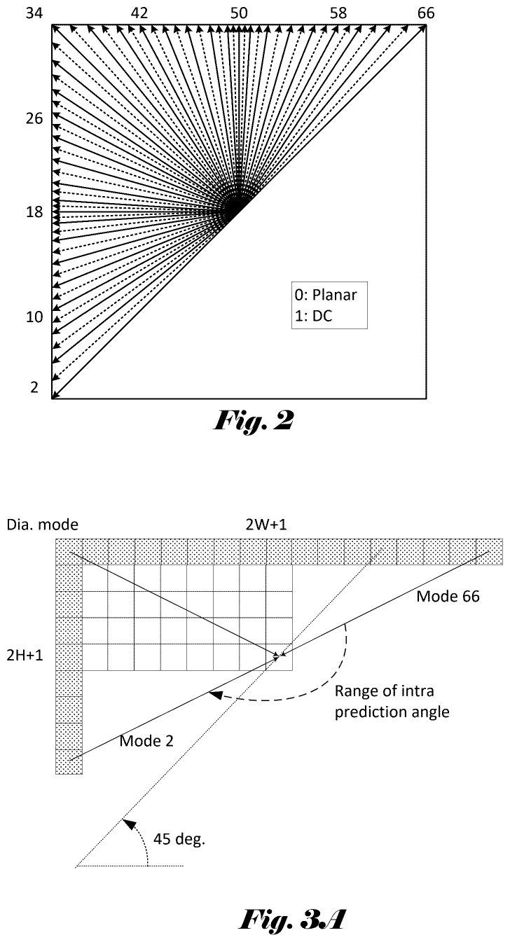

To capture the arbitrary edge directions presented in natural video, the number of directional intra modes in VVC is extended from 33, as used in HEVC, to 65. The new directional (angular) modes not in HEVC are depicted as dotted arrows in FIG. 2, and the planar and DC modes remain the same. These denser directional intra prediction modes are applied for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

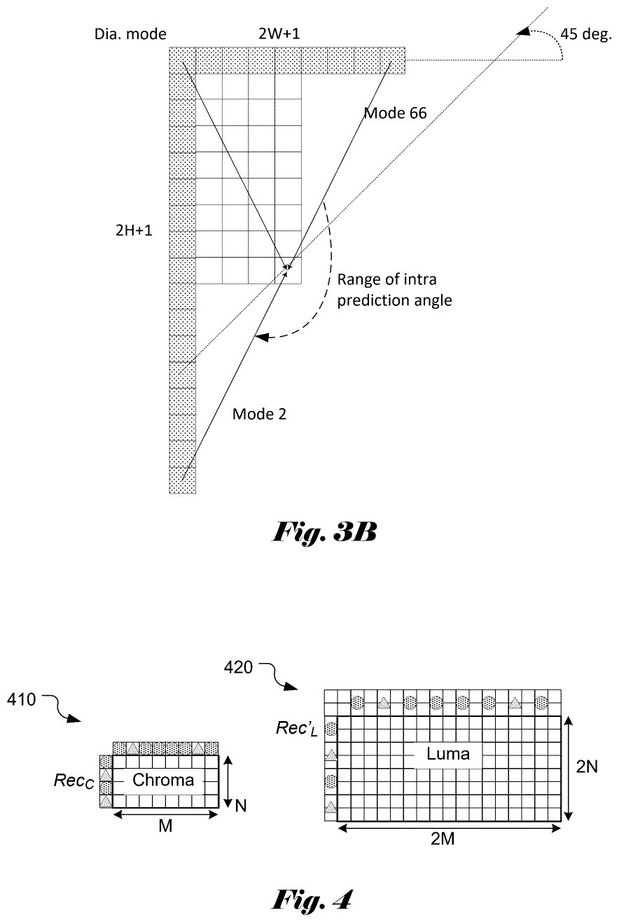

To support these prediction directions, the top reference with length 2W+1, and the left reference with length 2H+1, are defined as shown in FIG. 3A and FIG. 3B respectively.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2 chroma format is updated by replacing some values of the entries of the mapping table to convert prediction angle more precisely for chroma blocks.

### CCLM (Cross Component Linear Model)

The main idea behind CCLM mode (sometimes abbreviated as LM mode) is as follows: chroma components of a block can be predicted from the collocated reconstructed luma samples by linear models whose parameters are derived from already reconstructed luma and chroma samples that are adjacent to the block.

In VVC, the CCLM mode makes use of inter-channel dependencies by predicting the chroma samples from reconstructed luma samples. This prediction is carried out using a linear model in the form

$$P ( i , j ) = a \cdot {rec}_{L}^{′} ( i , j ) + b . \qquad ( 1 )$$

Here, P (i, j) represents the predicted chroma samples in a CU alu

$$r e {c}_{L}^{′} ( i , j )$$

represents the reconstructed luma samples of the same CU which are down-sampled for the case of non-4:4:4 colour format. The model parameters a and b are derived based on reconstructed neighbouring luma and chroma samples at both encoder and decoder side without explicit signalling.

Three CCLM modes, i.e., CCLM_LT, CCLM_L, and CCLM_T, are specified in VVC. These three modes differ with respect to the locations of the reference samples that are used for model parameter derivation. Samples only from the top boundary are involved in the CCLM_T mode and samples only from the left boundary are involved in the CCLM_L mode. In the CCLM_LT mode, samples from both the top boundary and the left boundary are used.

Overall, the prediction process of CCLM modes consists of three steps:
1) Down-sampling of the luma block and its neighbouring reconstructed samples to match the size of corresponding chroma block,
2) Model parameter derivation based on reconstructed neighbouring samples, and
3) Applying the model equation (1) to generate the chroma intra prediction samples.

Down-sampling of the Luma Component: To match the chroma sample locations for 4:2:0 or 4:2:2: colour format video sequences, two types of down-sampling filters can be applied to luma samples, both of which have a 2-to-1 down-sampling ratio in the horizontal and vertical directions. These two filters correspond to “type-0” and “type-2” 4:2:0 chroma format content, respectively and are given by

$${f}_{1} = ( \begin{matrix}0 & 1 & 0 \\ 1 & 4 & 1 \\ 0 & 1 & 0\end{matrix} ) , {f}_{2} = ( \begin{matrix}1 & 2 & 1 \\ 1 & 2 & 1\end{matrix} ) . \qquad ( 2 )$$

Based on the SPS (Sequence Parameter Set)-level flag information, the 2-dimensional 6-tap (i.e., f₂) or 5-tap (i.e., f₁) filter is applied to the luma samples within the current block as well as its neighbouring luma samples. The SPS-level refers to Sequence Parameter Set level. An exception happens if the top line of the current block is a CTU boundary. In this case, the one-dimensional filter [1, 2, 1]/4 is applied to the above neighbouring luma samples in order to avoid the usage of more than one luma line above the CTU boundary.

Model Parameter Derivation Process: The model parameters a and b from eqn. (1) are derived based on reconstructed neighbouring luma and chroma samples at both encoder and decoder sides to avoid the need for any signalling overhead. In the initially adopted version of the CCLM mode, the linear minimum mean square error (LMMSE) estimator was used for derivation of the parameters. In the final design, however, only four samples are involved to reduce the computational complexity. FIG. 4 shows the relative sample locations of M×N chroma block 410, the corresponding 2M×2N luma block 420 and their neighbouring samples (shown as filled circles and triangles) of “type-0” content.

In the example of FIG. 4, the four samples used in the CCLM_LT mode are shown, which are marked by triangular shape. They are located at the positions of M/4 and M·3/4 at the top boundary and at the positions of N/4 and N·3/4 at the left boundary. In CCLM_T and CCLM_L modes, the top and left boundary are extended to a size of (M+N) samples, and the four samples used for the model parameter derivation are located at the positions (M+N)/8, (M+N)·3/8, (M+N)·5/8, and (M+N)·7/8.

Once the four samples are selected, four comparison operations are used to determine the two smallest and the two largest luma sample values among them. Let Xₗ denote the average of the two largest luma sample values and let Xₛ denote the average of the two smallest luma sample values. Similarly, let Yₗ and Yₛ denote the averages of the corresponding chroma sample values. Then, the linear model parameters are obtained according to the following equation:

$$a = \frac{{Y}_{l} - {Y}_{s}}{{X}_{l} - {X}_{s}} \qquad ( 3 )$$

$$b = {Y}_{s} - a \cdot {X}_{s} .$$

In this equation, the division operation to calculate the parameter a is implemented with a look-up table. To reduce the memory required for storing this table, the diff value, which is the difference between the maximum and minimum values, and the parameter a are expressed by an exponential notation. Here, the value of diff is approximated with a 4-bit significant part and an exponent. Consequently, the table for 1/diff only consists of 16 elements. This has the benefit of both reducing the complexity of the calculation and decreasing the memory size required for storing the tables.

### MMLM Overview

As indicated by the name, the original CCLM mode employs one linear model for predicting the chroma samples from the luma samples for the whole CU, while in MMLM (Multiple Model CCLM), there can be two models. In MMLM, neighbouring luma samples and neighbouring chroma samples of the current block are classified into two groups, each group is used as a training set to derive a linear model (i.e., particular α and β are derived for a particular group). Furthermore, the samples of the current luma block are also classified based on the same rule for the classification of neighbouring luma samples.
Threshold is calculated as the average value of the neighbouring reconstructed luma samples. A neighbouring sample with Rec′L[x,y]<=Threshold is classified into group 1; while a neighbouring sample with Rec′L[x,y]>Threshold is classified into group 2.
Correspondingly, a prediction for chroma is obtained using linear models:

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix}$$

### Chroma Intra Mode Coding

For chroma intra mode coding, a total of 8 intra modes are allowed for chroma intra mode coding. Those modes include five traditional intra modes and three cross-component linear model modes ({LM_LA, LM_L, and LM_A} or {CCLM_LT, CCLM_L, and CCLM_T}). The terms of {LM_LA, LM_L, LM_A} and {CCLM_LT, CCLM_L, CCLM_T} are used interchangeably in this disclosure. Chroma mode signalling and derivation process are shown in Table 2. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 2
Derivation of chroma prediction mode from luma mode
when sps_cclm_enabled_flag is true

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 3.

TABLE 3
Unified binarization table for chroma prediction mode

| Value of intra_chroma_pred_mode | Bin string |
|---|---|
| 4 | 00 |
| 0 | 0100 |
| 1 | 0101 |
| 2 | 0110 |
| 3 | 0111 |
| 5 | 10 |
| 6 | 110 |
| 7 | 111 |

In Table 3, the first bin indicates whether it is regular (0) or LM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 3 are context coded with its own context model, and the rest bins are bypass coded.

### Multi-Hypothesis Prediction (MHP)

In the multi-hypothesis inter prediction mode (JVET-M0425), one or more additional motion-compensated prediction signals are signalled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

$${p}_{3} = ( 1 - α ) {p}_{bi} + α {h}_{3} \qquad ( 4 )$$

The weighting factor α is specified by the new syntax element add_hyp_weight_idx, according to the following mapping (Table 4):

TABLE 4
Mapping α to add_hyp_weight_idx

| add_hyp_weight_idx | α |
|---|---|
| 0 | ¼ |
| 1 | −1/8 |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} \qquad ( 5 )$$

The resulting overall prediction signal is obtained as the last pₙ (i.e., the pₙ having the largest index n). For example, up to two additional prediction signals can be used (i.e., n is limited to 2).

The motion parameters of each additional prediction hypothesis can be signalled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode. Details of MHP for VVC can be found in JVET-W2025 (Muhammed Coban, et. al., “Algorithm description of Enhanced Compression Model 2 (ECM 2)”, Joint Video Experts Team (JVET) of ITU-T SG 16 WP 3 and ISO/IEC JTC 1/SC 29, 23rd Meeting, by teleconference, 7-16 Jul. 2021, Document: JVET-W2025).

Combination of MHP and BDOF is possible, however the BDOF is only applied to the bi-prediction signal part of the prediction signal (i.e., the ordinary first two hypotheses).

### Template-Based Intra Mode Derivation (TIMD)

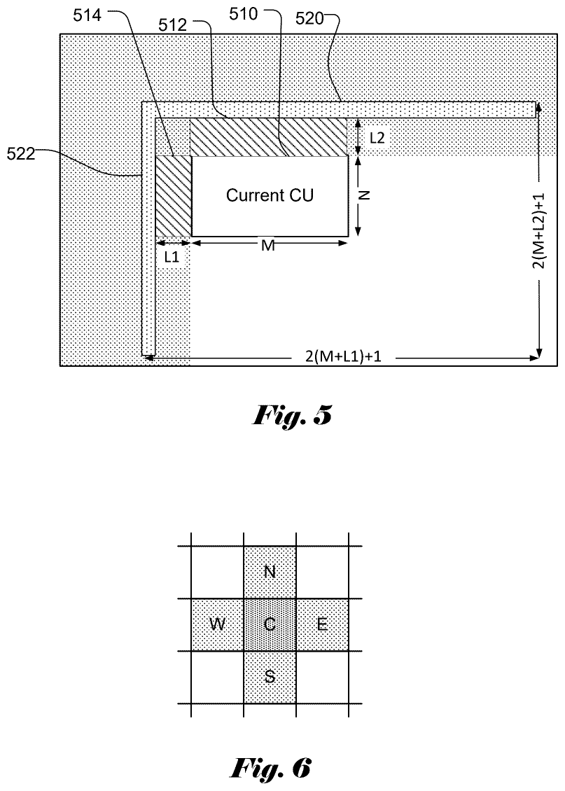

Template-based intra mode derivation (TIMD) mode implicitly derives the intra prediction mode of a CU using a neighbouring template at both the encoder and decoder, instead of signalling the intra prediction mode to the decoder. As shown in FIG. 5, the prediction samples of the template (512 and 514) for the current block 510 are generated using the reference samples (520 and 522) of the template for each candidate mode. A cost is calculated as the SATD (Sum of Absolute Transformed Differences) between the prediction samples and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$weight 1 = costMode 2 / ( costMode 1 + costMode 2 )$$

$$weight 2 = 1 - weight 1.$$

### Fusion of Chroma Intra Prediction Modes

During the development of emerging video coding system, it has been proposed that the DM mode and four default modes can be fused with the MMLM_LT mode as follows:

$$pred = ( w 0 * pred 0 + w 1 * pred 1 + ( 1 << ( shift - 1 ) ) ) >> shift .$$

In the above equation, pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0,w1}={1, 3}; when the above and left adjacent blocks are both coded with non-LM modes, {w0,w1}={3, 1}; otherwise, {w0,w1}={2, 2}.

For the syntax design, if a non-LM mode is selected, one flag is signalled to indicate whether the fusion is applied. And the proposed fusion is only applied to I slices.

### Convolutional Cross-Component Model (CCCM)

The convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as shown in FIG. 6.

The nonlinear term (denoted as P) is represented as power of two of the centre luma sample C and scaled to the sample value range of the content:

$$P = ( C * C + midVal ) >> \text{bitDepth.}$$

For example, for 10-bit contents, the nonlinear term is calculated as:

$$P = ( C * C + 5 \; 12 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = c 0 C + c 1 N + c 2 S + c 3 E + c 4 W + c 5 P + c 6 B$$

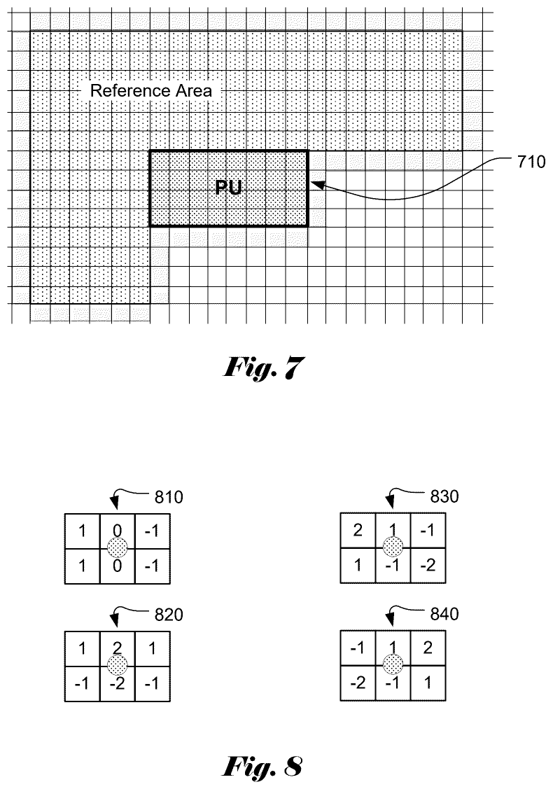

The filter coefficients ci are calculated by minimising MSE (Mean Squared Error) between predicted and reconstructed chroma samples in the reference area. FIG. 7 illustrates an example of the reference area which consists of 6 lines of chroma samples above and left of the PU 710. Reference area extends one PU width to the right and one PU height below the PU boundaries. Area is adjusted to include only available samples. The extensions to the area (indicated as “light grey squares) are needed to support the “side samples” (i.e., N, S, W and E samples in FIG. 5) of the plus-shaped spatial filter in FIG. 7 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA (this mode indicating LM modes being used).

### Gradient Linear Model (GLM)

Compared with CCLM, instead of down-sampled luma values, the GLM utilizes luma sample gradients to derive the linear model. In other words, rather than the low-pass filtered luma sample, a gradient G is replaced in the CCLM process. The other designs of CCLM (e.g., parameter derivation, prediction sample linear transform) are kept unchanged.

$$C = α \cdot G + β$$

FIG. 8 shows that G can be calculated by one of four Sobel based gradient patterns (810, 820, 830 and 840).

For signalling, when the CCLM mode is enabled to the current CU, two flags are signalled separately for Cb/Cr component to indicate whether GLM is enabled to the component; if the GLM is enabled for one component, one syntax element is further signalled to select one of four gradient patterns in FIG. 8 for gradient calculation.

### Proposed Method

To improve video coding efficiency, many coding tools are designed for more efficient signalling and/or to generate better predictors of blocks. With the traditional mechanism, an inter mode utilizes temporal information to predict the current block. For an intra block, spatially neighbouring reference samples are used to predict the current block. In this invention, a coding tool that creates a new blending mode and has multiple choices of reference lines to form a better predictor is disclosed. The concept of this coding tool is described as follows.

In one embodiment, the proposed coding tool can be any cross-component tool that predicts and/or reconstructs samples of the current encoding/decoding colour component depending on the information of one or more other colour component(s).
For example, the cross-component tool is to generate the predicted and/or reconstructed samples of Cb/Cr depending on the information of luma.
For another example, the cross-component tool is to generate the predicted and/or reconstructed samples of Cr depending on the information of Cb.
For another example, the cross-component tool refers to CCLM, MMLM and/or GLM.

In another embodiment, an additional hypothesis of intra prediction (denoted as H2) is blended with the existing hypothesis of intra prediction (denoted as H1) by a pre-defined weighting to form the final prediction of the current block. H1 is generated by one mode (denoted as M1) selected from the first mode set (denoted as Set1), and H2 is generated by one mode (denoted as M2) selected from the second mode set (denoted as Set2). M1 and M2 can be any intra modes. Intra modes refer modes used to generate intra block predictions. For example, the 67 intra prediction modes, CCLM modes and MMLM modes earlier.

In another embodiment, M1 and M2 can be any LM modes. LM modes refer to modes that predict chroma component of a block by the collocated reconstructed luma samples by linear models, where parameters are derived from already reconstructed luma and chroma samples that are adjacent to the block. LM modes includes CCLM and MMLM.

In one embodiment, Set1 includes CCLM_LT, CCLM_L, CCLM_T, MMLM_LT, MMLM_L, MMLM_T, or any subset of the above modes, or any extension of LM family.

In one embodiment, Set2 includes CCLM_LT, CCLM_L, CCLM_T, MMLM_LT, MMLM_L, MMLM_T, or any subset of the above modes, or any extension of LM family.

In one embodiment, M1 is one of the CCLM modes and M2 is one of the CCLM modes. Hence Set1 includes CCLM_LT, CCLM_L, CCLM_T, and Set2 also includes CCLM_LT, CCLM_L, CCLM_T. The combinations of {M1, M2} (or {M2, M1}) include:
{CCLM_LT, CCLM_L}, {CCLM_LT, CCLM_T}, {CCLM_L, CCLM_T}

In another embodiment, M1 is one of the CCLM modes and M2 is one of the MMLM modes. Hence Set1 includes CCLM_LT, CCLM_L, CCLM_T, and Set2 includes MMLM_LT, MMLM_L, MMLM_T. The combinations of {M1, M2} include:
{CCLM_LT, MMLM_LT}, {CCLM_LT, MMLM_L}, {CCLM_LT, MMLM_T},
{CCLM_L, MMLM_LT}, {CCLM_L, MMLM_L}, {CCLM_L, MMLM_T}
{CCLM_T, MMLM_LT}, {CCLM_T, MMLM_L}, {CCLM_T, MMLM_T}

In another embodiment, M1 is one of the MMLM modes and M2 is one of the MMLM modes. Hence Set1 includes MMLM_LT, MMLM_L, MMLM_T, and Set2 also includes MMLM_LT, MMLM_L, MMLM_T. The combinations of {M1, M2} (or {M2, M1}) include:
{MMLM_LT, MMLM_L}, {MMLM_LT, MMLM_T}, {MMLM_L, MMLM_T}

In another embodiment, M1 is one of the CCLM modes and M2 can be one of the CCLM or MMLM modes. Hence Set1 includes CCLM_LT, CCLM_L, CCLM_T, and Set2 includes CCLM_LT, CCLM_L, CCLM_T, MMLM_LT, MMLM_L, MMLM_T. The combinations of {M1, M2} (or {M2, M1}) include:
{CCLM_LT, CCLM_L}, {CCLM_LT, CCLM_T}, {CCLM_L, CCLM_T},

The combinations of {M1, M2} also include:
{CCLM_LT, MMLM_LT}, {CCLM_LT, MMLM_L}, {CCLM_LT, MMLM_T},
{CCLM_L, MMLM_LT}, {CCLM_L, MMLM_L}, {CCLM_L, MMLM_T}
{CCLM_T, MMLM_LT}, {CCLM_T, MMLM_L}, {CCLM_T, MMLM_T}

In another embodiment, M1 can be one of the CCLM or MMLM modes, and M2 is one of the CCLM or MMLM modes. When M1 is a CCLM mode, M2 must also be a CCLM mode. When M1 is a MMLM mode, M2 must be one of the MMLM modes. The combinations of {M1, M2} (or {M2, M1}) include:
{CCLM_LT, CCLM_L}, {CCLM_LT, CCLM_T}, {CCLM_L, CCLM_T},
{MMLM_LT, MMLM_L}, {MMLM_LT, MMLM_T}, {MMLM_L, MMLM_T}

In another embodiment, M1 is one of the CCLM or MMLM modes and M2 can be one of the MMLM modes. Hence Set1 includes CCLM_LT, CCLM_L, CCLM_T, MMLM_LT, MMLM_L, MMLM_T, and Set2 includes MMLM_LT, MMLM_L, MMLM_T. The combinations of {M1, M2} include:
{CCLM_LT, MMLM_LT}, {CCLM_LT, MMLM_L}, {CCLM_LT, MMLM_T},
{CCLM_L, MMLM_LT}, {CCLM_L, MMLM_L}, {CCLM_L, MMLM_T}
{CCLM_T, MMLM_LT}, {CCLM_T, MMLM_L}, {CCLM_T, MMLM_T}

The combinations of {M1, M2} (or {M2, M1}) also include:
{MMLM_LT, MMLM_L}, {MMLM_LT, MMLM_T}, {MMLM_L, MMLM_T}

In another embodiment, M1 is one of the CCLM or MMLM modes and M2 can be one of the CCLM or MMLM modes. Hence Set1 includes CCLM_LT, CCLM_L, CCLM_T, MMLM_LT, MMLM_L, MMLM_T, and Set2 also includes CCLM_LT, CCLM_L, CCLM_T, MMLM_LT, MMLM_L, MMLM_T. The combinations of {M1, M2} (or {M2, M1}) include:
{CCLM_LT, CCLM_L}, {CCLM_LT, CCLM_T}, {CCLM_L, CCLM_T}
{CCLM_LT, MMLM_LT}, {CCLM_LT, MMLM_L}, {CCLM_LT, MMLM_T},
{CCLM_L, MMLM_LT}, {CCLM_L, MMLM_L}, {CCLM_L, MMLM_T}
{CCLM_T, MMLM_LT}, {CCLM_T, MMLM_L}, {CCLM_T, MMLM_T}
{MMLM_LT, MMLM_L}, {MMLM_LT, MMLM_T}, {MMLM_L, MMLM_T}

In one embodiment, this coding tool is applied to blocks of any colour component. For example, it can be applied to luma component and/or chroma components. For another example, it can be applied to luma component and/or Cb component. For another example, it can be applied to luma component and/or Cr component.

In another embodiment, this coding tool is applied to blocks of chroma components. For example, it can be applied to Cb and/or Cr components.

In one embodiment, M1 and M2 are derived using TIMD method, where TIMD process is described as following. As show in FIG. 5, the linear model of each allowed modes for M1 and M2 are derived using the reference samples of the template. Each linear model is applied on the samples of one or more other colour component of the template to generate the prediction samples of the current encoding/decoding colour component of the template. The TIMD cost is then computed as the distortion between the prediction and the reconstruction samples of the template. The modes with the smallest TIMD cost among the allowed modes are selected. For example, if M1 is allowed to be one of the CCLM modes and M2 is allowed to be one of the MMLM modes. The mode with the smallest TIMD cost among CCLM_LT, CCLM_L, CCLM_T is selected to be M1, and the mode with the smallest TIMD cost among MMLM_LT, MMLM_L, MMLM_T is selected to be M2. For another example, if both M1 and M2 is allowed to be one of the CCLM modes, the modes with the smallest and second smallest TIMD cost among CCLM_LT, CCLM_L, CCLM_T are selected to be M1 and M2.

In another embodiment, M1 is explicitly signalled, and M2 is derived using TIMD method. The linear model of each allowed modes for M2 are derived using the reference samples of the template. Each linear model is applied on the samples of one or more other colour component of the template to generate the prediction samples of the current encoding/decoding colour component of the template. The TIMD cost is then computed as the distortion between the prediction and the reconstruction samples of the template. The mode with the smallest TIMD cost among the allowed modes is selected as M2. For example, if M2 is allowed to be one of the MMLM modes. The mode with the smallest TIMD cost among MMLM_LT, MMLM_L, MMLM_T is selected to be M2.

In one embodiment, the blending weight of H1 and H2 is implicitly decided. For example, the weighting can be inferred as equal weighting.

In another embodiment, the weighting is implicitly decided by TIMD cost. TIMD cost is defined as follows. For each mode, as shown in FIG. 5, using the linear model derived based on the reference samples of the template, the prediction samples of the current encoding/decoding colour component of the template are generated by applying the linear model on the samples of one or more other colour component of the template. TIMD cost is calculated as the SATD between the prediction and the reconstruction samples of the template. TIMD cost can be determined at the decoder and do not need to be signalled. For example, if the mode for generating H1 has a larger TIMD cost, H1 uses a smaller weight during blending. If the mode for generating H2 has a larger TIMD cost, H2 uses a smaller weight during blending. For another example, the weighting is inversely proportional to TIMD cost

$${w}_{h 1} = \frac{{TIMD}_{{cost}_{h 2}}}{( {TIMD}_{{cost}_{h 1}} + {TIMD}_{{cost}_{h 2}} )}$$

$${w}_{h 2} = \frac{{TIMD}_{{cost}_{h 1}}}{( {TIMD}_{{cost}_{h 1}} + {TIMD}_{{cost}_{h 2}} )}$$

In another embodiment, if the mode for generating H1 has a much larger TIMD cost than H2, only H2 is used to form the final prediction. For example, let k be a value greater than one. When TIMD_costₕ₁>k*TIMD_costₕ₂, only H2 is used to form the final prediction.

In another embodiment, if the mode for generating H2 has a much larger TIMD cost than H1, only H1 is used to form the final prediction. For example, let k be a value greater than one. When TIMD_costₕ₂>k*TIMD_costₕ₁, only H1 is used to form the final prediction.

In another embodiment, the weighting is selected from a pre-determined weight set. For example, the weight set includes {(0, 4), (1, 3), (2, 2), (3, 1), (4, 0)}. After the modes M1 and M2 are selected, the template prediction based on M1 is blended with the template prediction based on M2 with each weighting in the weight set. The distortion corresponding to each weighting in the weight set (i.e, the difference between the blended template prediction generated based on the weighting and the reconstruction samples of the templates) is calculated. The weighting that has the smallest distortion is then selected from the weight set.

In one embodiment, when the current block has multiple reference lines, the outer adjacent line (920/922) of the template (910/912) is selected to be the reference line of the template as shown in FIG. 9. The linear model applied on the template is derived from the reference line of the template. The outer adjacent line (930/932) of the block is selected to be the reference line of the encoding block as shown in FIG. 9. The linear model applied on the current block is derived from the reference line of the current block.

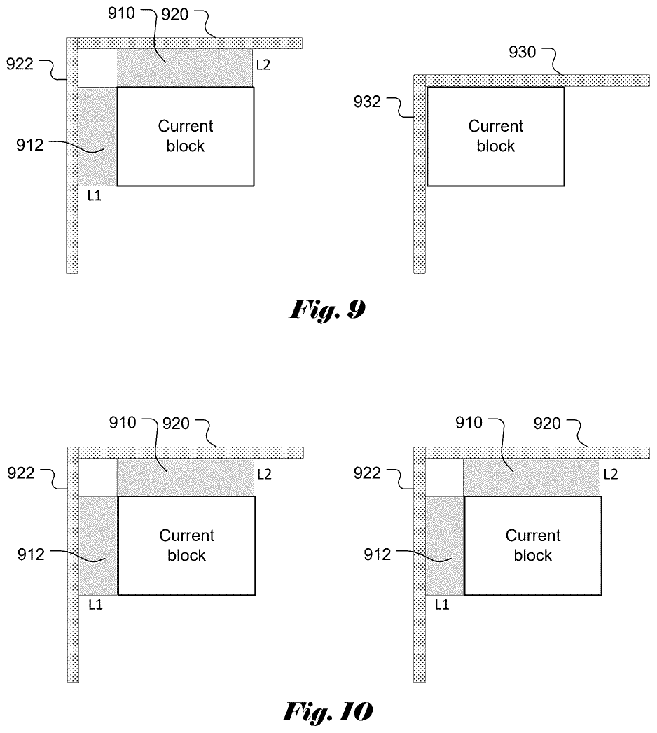

In another embodiment, when the current block has multiple reference lines, the outer adjacent line (920/922) of the template is selected to be the reference line of the template (910/912) as shown in FIG. 10. The reference line (920/922) of the encoding block is also the outer adjacent line of the template as shown in FIG. 10. Both the linear model applied on the template and the linear model applied on the current block are derived from the same reference line.

In one sub-embodiment, selection of the reference line (for generating predicted samples inside the template and/or the current block) depends on the template size (e.g. L2 for the top template and/or L1 for the left template) and the template size is adaptive according to the width, height, and/or area of the current block, and/or defined according to explicit signalling. In more details, the template includes the top template and/or the left template. The area of the top template is defined with the width of the current block multiplied by L2 and the area of the left template is defined with L1 multiplied by the height of the current block. In this invention, L1 and L2 are jointly set with the same value or individually set with same or different values. The proposed methods in this embodiment can be applied to adaptively set L1 and/or L2.

In one example, for the blocks with area larger than a predefined threshold (e.g. 4, 8, 16, 32, 64, 128, 256, or any positive integer), the setting for L1 and/or L2 can be as follows:
In one way, the template size gets larger (e.g. originally 2, enlarging to 4).
In another way, the template size gets smaller (e.g. originally 4, reducing to 2).
In another way, the number of candidate template sizes is increased and a longer indication is derived/signalled to specify the used template size.
In another way, the number of candidate template sizes is reduced and a short indication is derived/signalled to specify the used template size.

In another example, for the blocks with size (e.g. width or height) larger than a predefined threshold (e.g. 4, 8, 16, 32, 64, 128, 256, maximum transform size specified in the standard, or any positive integer), the setting for L1 and/or L2 can be as follows:
In one way, the template size gets larger (e.g. originally 2, enlarging to 4).
In another way, the template size gets smaller (e.g. originally 4, reducing to 2).
In another way, the number of candidate template sizes is increased and a longer indication is derived/signalled to specify the used template size.
In another way, the number of candidate template sizes is reduced and a short indication is derived/signalled to specify the used template size.

In another embodiment, the reference lines from the used multiple colour components are aligned or related. That is, after deciding the reference line of one used colour component, the reference line of other used colour component(s) can be derived accordingly. Take CCLM/MMLM as an example. When deriving the model parameters (e.g. scaling factor a and/or offset b), the inputs include the down-sampled reference luma line and the reference chroma (Cb or Cr) line and after deciding the down-sampled reference luma line, the reference chroma line can be derived accordingly. In one way, the reference chroma line is aligned with the down-sampled reference luma line. In another way, the reference chroma line is derived with the down-sampled reference luma line and an offset where the offset is implicitly set as a pre-defined value, adaptively decided according to the width, height, area of the current block, and/or explicitly decided according to the signalling at block, slice, picture, SPS, or PPS (Picture Parameter Set) level. In another way, the down-sampled reference luma line is derived with the reference chroma line and an offset, where the offset is implicitly set as a pre-defined value, adaptively decided according to the width, height, area of the current block, and/or explicitly decided according to the signalling at block, slice, picture, SPS, or PPS level.

In another embodiment, the term “block” in this invention can refer to a TU/TB, CU/CB, PU/PB, CTU/CTB, or any predefined region.

In another embodiment, when the current block has multiple reference lines, both the reference line of the template and the reference line of the current block are the outer adjacent line of the current block. Both the linear model applied on the template (1110/1112) and the linear model applied on the current block are derived from the same reference line (930/932) as shown in FIG. 11. The template is located outside of the reference line.

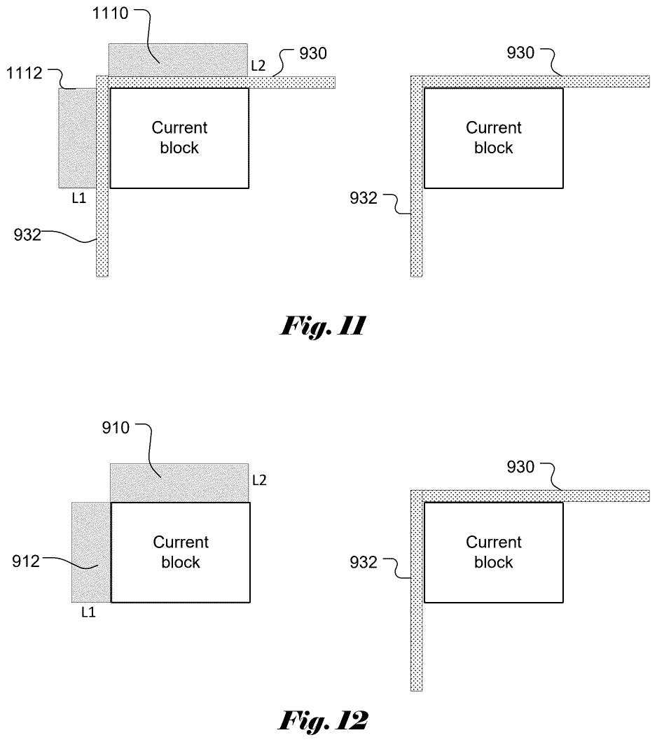

In another embodiment, when the current block has multiple reference lines, both the reference line (930/932) of the template and the reference line (930/932) of the current block are the outer adjacent line of the current block as shown in FIG. 12. Both the linear model applied on the template and the linear model applied on the current block are derived from the same reference line (930/932). The template (910/912) is located immediately outside of the current block.

In one embodiment, a flag is signalled/parsed at a block-level to indicate that an “MRL (multiple reference line) mode” is applied to the current block. For example, the flag can be signalled at CU level and/or PU level and/or CTU level. For another example, the flag can be signalled at CB level, PB level, CTB, TU/TB, any predefined region level, or any combination thereof.

In one embodiment, when the flag indicates that the “MRL mode” is disabled, the original syntax for signalling/parsing an intra prediction mode for the current block is followed. When the flag indicates that the “MRL mode” is enabled, the blending mode is applied, M1, M2 and blending weights are derived.

In another embodiment, M1 is explicitly signalled, and a flag is signalled/parsed to indicate whether to apply the “MRL mode” to the current block.

In one sub-embodiment, when the “MRL mode” flag is enabled, the blending mode is enabled, M2 and the blending weight are derived. When the flag is disabled, no blending is used.

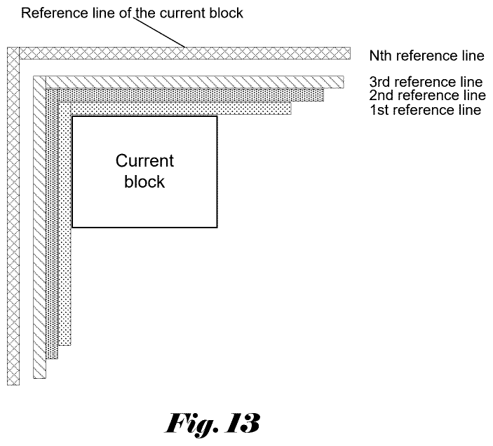

In one sub-embodiment, when the “MRL mode” flag is enabled, and M1 is one of the CCLM modes (CCLM_LT, CCLM_L, CCLM_T), the blending mode is enabled, M2 and the blending weight are derived. When the “MRL mode” flag is enabled and M1 is one of the MMLM modes (MMLM_LT, MMLM_L, MMLM_T), only M1 is used to generate the predictor and no blending is used. The reference line used to derive the linear model is signalled. When the flag is disabled, the reference line used to derive is the outer adjacent line of the block (1^{st} reference line as FIG. 13) and is not signalled.

In one embodiment, the modes selected to generate H1 and H2 are implicitly decided. When the template above the current CU and the template on the left side of the current CU (as depicted in FIG. 5) are both unavailable, the blending mode is disabled.

In one embodiment, the tool proposed in this invention is not to use together with CCCM and GLM. If the “MRL mode” flag is on, the syntaxes related to CCCM and GLM are bypassed. If the “MRL mode” flag is off, the syntaxes related to CCCM and GLM are sent. For another example, if CCCM or GLM mode is used, the syntax of “MRL mode” flag is bypassed. If CCCM or GLM mode is used, the syntax of “MRL mode” flag is signalled.

In another embodiment, the tool proposed in this invention is used together with CCCM and GLM. The syntaxes related to CCCM and GLM are sent regardless the “MRL mode” flag is on or off. If the “MRL mode” flag is on, the setting related to CCCM and GLM are applied. For example, CCCM or GLM model are used instead of CCLM or MMLM model. For another example, the number of reference lines used is 6 instead of 1. If the “MRL mode” flag is off, the decoder functions as CCCM or GLM syntaxes indicate.

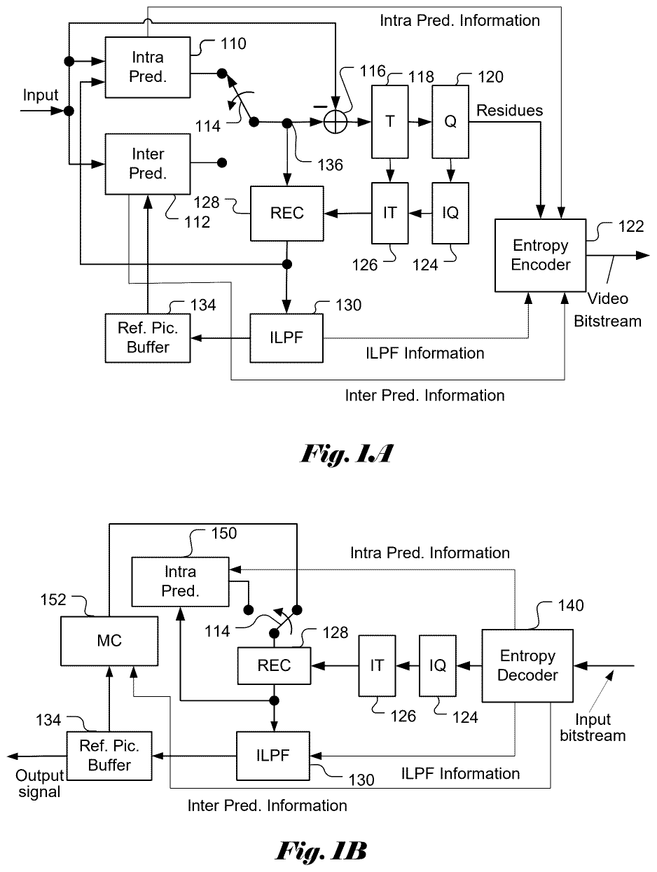

Any of the foregoing proposed implicit linear model derivation with multiple reference lines can be implemented in encoders and/or decoders. For example, any of the proposed methods can be implemented in an intra coding module (e.g. Intra Pred. 110 in FIG. 1A) of an encoder, or an intra coding module (e.g. Intra Pred. 150 in FIG. 1B) of a decoder. Alternatively, any of the proposed methods can be implemented as a circuit coupled to the intra coding module of an encoder and/or the decoder.

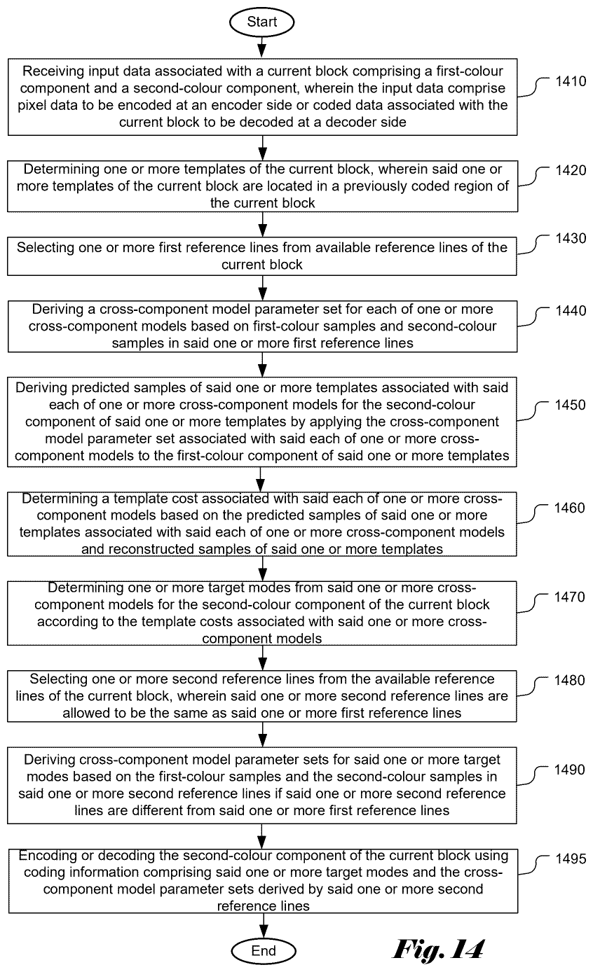

FIG. 14 illustrates a flowchart of an exemplary video coding system that implicitly derives a linear model predictor with based on TIMD (Template-based Intra Mode Derivation) according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block comprising a first-colour component and a second-colour component are received in step 1410, wherein the input data comprise pixel data to be encoded at an encoder side or coded data associated with the current block to be decoded at a decoder side. One or more templates of the current block are determined in step 1420, wherein said one or more templates of the current block are located in a previously coded region of the current block. One or more first reference lines are selected from available reference lines of the current block in step 1430. A cross-component model parameter set for each of one or more cross-component models are derived based on first-colour samples and second-colour samples in said one or more first reference lines in step 1440. Predicted samples of said one or more templates associated with said each of one or more cross-component models for the second-colour component of said one or more templates are derived by applying the cross-component model parameter set associated with said each of one or more cross-component models to the first-colour component of said one or more templates in step 1450. A template cost associated with said each of one or more cross-component models are determined based on the predicted samples of said one or more templates associated with said each of one or more cross-component models and reconstructed samples of said one or more templates in step 1460. One or more target modes from said one or more cross-component models are determined for the second-colour component of the current block according to the template costs associated with said one or more cross-component models in step 1470. One or more second reference lines from the available reference lines of the current block are selected, wherein said one or more second reference lines are allowed to be the same as said one or more first reference lines in step 1480. The cross-component model parameter sets for said one or more target modes are derived based on the first-colour samples and the second-colour samples in said one or more second reference lines if said one or more second reference lines are different from said one or more first reference lines in step 1490. The second-colour component of the current block is encoded or decoded using coding information comprising said one or more target modes and the cross-component model parameter sets derived by said one or more second reference lines in step 1495.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures, the method comprising:
receiving input data associated with a current block comprising a first-colour component and a second-colour component, wherein the input data comprise pixel data to be encoded at an encoder side or coded data associated with the current block to be decoded at a decoder side;
determining one or more templates of the current block, wherein said one or more templates of the current block are located in a previously coded region of the current block;
selecting one or more first reference lines from available reference lines of the current block;
deriving a cross-component model parameter set for each of one or more cross-component models based on first-colour samples and second-colour samples in said one or more first reference lines;
deriving predicted samples of said one or more templates associated with said each of one or more cross-component models for the second-colour component of said one or more templates by applying the cross-component model parameter set associated with said each of one or more cross-component models to the first-colour component of said one or more templates;
determining a template cost associated with said each of one or more cross-component models based on the predicted samples of said one or more templates associated with said each of one or more cross-component models and reconstructed samples of said one or more templates;
determining one or more target modes from said one or more cross-component models for the second-colour component of the current block according to the template costs associated with said one or more cross-component models;
selecting one or more second reference lines from the available reference lines of the current block, wherein said one or more second reference lines are allowed to be the same as said one or more first reference lines;
deriving cross-component model parameter sets for said one or more target modes based on the first-colour samples and the second-colour samples in said one or more second reference lines if said one or more second reference lines are different from said one or more first reference lines; and
encoding or decoding the second-colour component of the current block using coding information comprising said one or more target modes and the cross-component model parameter sets derived by said one or more second reference lines.

2. The method of claim 1, wherein the template cost associated with said each of one or more cross-component models corresponds to distortion between the predicted samples of said one or more templates associated with said each of one or more cross-component models and the reconstructed samples of said one or more templates.

3. The method of claim 2, wherein said one or more target modes selected from said one or more cross-component models have smallest template costs among the template costs associated with said one or more cross-component models.

4. The method of claim 1, wherein the current block is encoded or decoded using a final predictor by blending a first predictor associated with a first prediction mode and a second predictor associated with a second prediction mode, and wherein at least one of the first prediction mode and the second prediction mode is implicitly determined according to the template costs associated with said one or more cross-component models.

5. The method of claim 4, wherein the first prediction mode is determined explicitly by signalling or parsing an index, and said one or more cross-component models are associated with a cross-component model set and the second prediction mode is determined implicitly according to the template costs associated with said one or more cross-component models in the cross-component model set.

6. The method of claim 5, wherein the final predictor is generated as a weighted sum of the first predictor and the second predictor.

7. The method of claim 6, wherein a weighting factor for the weighted sum of the first predictor and the second predictor is determined implicitly based on a first template cost associated with the first prediction mode and a second template cost associated with the second prediction mode.

8. The method of claim 7, wherein the first template cost is determined by deriving a first cross-component parameter set based on the samples on said one or more first reference lines and a signalled first prediction mode, and then determined based on the predicted samples of said one or more templates and reconstructed samples of said one or more templates, and wherein the predicted samples of said one or more templates are generated according to the signalled first prediction mode with the first cross-component parameter set derived.

9. The method of claim 6, wherein a flag is signalled or parsed to indicate whether MRL (Multiple Reference Lines) mode is enabled for the current block and when the flag indicates the MRL mode being enabled for the current block, the second prediction mode is determined and a weighting factor for the weighted sum of the first predictor and the second predictor is derived.

10. The method of claim 9, wherein the first predictor is generated based on one cross-component parameter set derived based on said one or more second reference lines with the first prediction mode.

11. The method of claim 9, wherein said one or more first reference lines from the available reference lines correspond to one or more outer adjacent reference lines of said one or more templates of the current block, and the second reference lines are the same as the first reference lines.

12. The method of claim 9, wherein said one or more cross-component models are associated with a second cross-component model set, the flag is signalled only if the first prediction mode is in the second cross-component model set.

13. The method of claim 12, wherein if the first prediction mode is not in the second cross-component model set, the flag is not signalled and the MRL mode is implicitly determined as disabled.

14. The method of claim 4, wherein said one or more cross-component models are associated with a first cross-component model set and a second cross-component model set, and wherein a first target mode is derived from the first cross-component model set and a second target mode is derived from the second cross-component model set.

15. The method of claim 14, wherein the final predictor is generated as a weighted sum of the first predictor and the second predictor.

16. The method of claim 15, wherein a weighting factor for the weighted sum of the first predictor and the second predictor is determined implicitly based on a first template cost associated with the first prediction mode and a second template cost associated with the second prediction mode.

17. The method of claim 16, wherein a flag is signalled or parsed to indicate whether MRL (Multiple Reference Lines) mode is enabled for the current block and when the flag indicates the MRL mode being enabled for the current block, the first prediction mode and the second prediction mode are determined and the weighting factor for the weighted sum of the first predictor and the second predictor is derived.

18. The method of claim 14, wherein the first cross-component model set and the second cross-component model set only contain linear model modes.

19. The method of claim 14, wherein the first prediction mode is determined implicitly from the first cross-component model set and the second prediction mode is determined implicitly from the second cross-component model set.

20. An apparatus for video coding, the apparatus comprising one or more electronics or processors arranged to:
receive input data associated with a current block comprising a first-colour component and a second-colour component, wherein the input data comprise pixel data to be encoded at an encoder side or coded data associated with the current block to be decoded at a decoder side;
determine one or more templates of the current block, wherein said one or more templates of the current block are located in a previously coded region of the current block;
select one or more first reference lines from available reference lines of the current block;
derive a cross-component model parameter set for each of one or more cross-component models based on first-colour samples and second-colour samples in said one or more first reference lines;
derive predicted samples of said one or more templates associated with said each of one or more cross-component models for the second-colour component of said one or more templates by applying the cross-component model parameter set associated with said each of one or more cross-component models to the first-colour component of said one or more templates;
determine a template cost associated with said each of one or more cross-component models based on the predicted samples of said one or more templates associated with said each of one or more cross-component models and reconstructed samples of said one or more templates;
determine one or more target modes from said one or more cross-component models for the second-colour component of the current block according to the template costs associated with said one or more cross-component models;
select one or more second reference lines from the available reference lines of the current block, wherein said one or more second reference lines are allowed to be the same as said one or more first reference lines;
derive cross-component model parameter sets for said one or more target modes based on the first-colour samples and the second-colour samples in said one or more second reference lines if said one or more second reference lines are different from said one or more first reference lines; and
encode or decode the second-colour component of the current block using coding information comprising said one or more target modes and the cross-component model parameter sets derived by said one or more second reference lines.
